(19) United States
(12) Patent Application Publication
(10) Pub. No.: US 2024/0420262 A1
(43) Pub. Date: Dec. 19, 2024

(54) SYSTEMS AND METHODS FOR APPLYING LARGE LANGUAGE MODELS TO CONTRACT PRIORITIZATION

(71) Applicant: KINVESTING, LLC, Clio, MI (US)

(72) Inventor: Raymond Kusch, Clio, MI (US)

(21) Appl. No.: 18/740,067

(22) Filed: Jun. 11, 2024

Related U.S. Application Data
(60) Provisional application No. 63/507,976, filed on Jun. 13, 2023.

(51) Int. Cl. G06Q 50/18; G06F 40/205; G06F 40/30; G06F 40/40; G06N 20/00

(52) U.S. Cl. CPC G06Q 50/18; G06F 40/205; G06F 40/30; G06F 40/40; G06N 20/00

(57) ABSTRACT

A computer-implemented method to train or guide a machine learning model to generate a contract proposal document may include receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document; and generating the contract proposal document using the generated input according to the training based on the first natural language model and the training based on the second natural learning model.

### CROSS-REFERENCE TO RELATED APPLICATION

This application claims the priority benefit of U.S. Provisional Application No. 63/507,976, filed on Jun. 13, 2023, the disclosure of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### SUMMARY

In some aspects, the techniques described herein relate to a computer-implemented method to train or guide a machine learning model to generate a contract proposal document, the method including: receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document, wherein the generated input includes text that mimics semantics of the textual data to adhere to the plurality of requirements; and generating the contract proposal document using the generated input according to the training based on the first natural language model and the training based on the second natural learning model.

In some aspects, the techniques described herein relate to a computer-implemented method for predicting a probability of winning contract work, the method including: obtaining information including a plurality of identifiers, a plurality of contract documents, a plurality of available contract work, and historical data about awarded contracts; determining a likelihood, based on the obtained information and for each of the plurality of identifiers, of winning the respective contract work according to the plurality of contract documents and the historical data about awarded contracts, the determining including; ranking the determined likelihoods of winning the respective contract work; generating, based on the ranking, at least one bid and a contract proposal document for contract work having a ranking above a predefined level.

In some aspects, the techniques described herein relate to a computer-implemented method of prioritizing contracts, the method including: training a first LLM model using existing contracts associated with a single or multiple companies; applying unsupervised learning to orient the first LLM toward government contracts; applying supervised learning from the previous contracts to tune the first LLM to increase predictive potential of the first LLM; tuning the first LLM to read and interpret government based contracts; adjusting one or more settings or parameters of the first LLM to increase a predictive capability of the first LLM; training a second LLM using available contracts associated with the single or multiple companies; applying unsupervised learning to orient the second LLM toward the government based contracts; applying supervised learning from the previous contracts to tune the second LLM to increase a predictive potential of the second LLM; tuning the second LLM to read and interpret the available contracts; adjusting one or more settings or parameters of the second LLM to increase a predictive capability of the second LLM; and applying reinforcement learning on the first LLM to cause the first LLM to output specific answers that mimic an expert proposal writer; and generating a new contract proposal document and inserting the specific answers into the contract proposal document.

### TECHNICAL FIELD

This disclosure relates generally to the field of applied Artificial Intelligence, and more specifically to the field of training and applying machine learning models, neural network models, deep learning models, or Natural Language Processing such as Large Language Models to contract and/or request for proposal prioritization and/or proposal drafting. Described herein are systems and methods for applying large language models to contract prioritization and proposal drafting.

### BACKGROUND

The U.S. Government contracting landscape has become increasingly challenging for businesses to navigate. The process is often complex and time-consuming, with lengthy proposal preparation and evaluation cycles. Moreover, the requirements and specifications of the various government agencies are frequently evolving, which makes it difficult for businesses to anticipate their specific needs and preferences. These issues create an environment with considerable barriers to entry and ultimately result in a significant drain on company resources. Furthermore, typical government financial constraints often mean that only the largest, most established firms are able to pursue opportunities successfully. Consequently, the playing field has proven to be tilted in favor of established government contractors, making it difficult for new businesses to participate, let alone compete, effectively.

The length of a Request for Proposal (RFP) or a Request for Quotation (RFQ) can vary widely based on the complexity and scope of the project. An RFP or RFQ might be just a few pages long for relatively simple projects. However, for complex, high-value projects, the RFP or RFQ could be hundreds of pages long. For example, it is not uncommon for an RFP or RFQ to be between 30 to 50 pages. Unfortunately, the SOW length is not necessarily indicative of its complexity. Even short RFPs or RFQs can be quite complex if they involve specialized work. Due to this, contractors must pay close attention to every detail in these documents, as they form the basis for the proposal and, ultimately, the contract itself. Finding and qualifying contracts and writing a competitive government contracting proposal can present several challenges.

Because of these challenges, many businesses opt to invest in specialized training, hire experienced consultants, or develop an in-house team dedicated to government contracts, if they continue to proceed at all. Furthermore, every day an additional—likely large but unknown—number of businesses are denied the ability to participate in this industry altogether because of the government's glass barriers to entry. Accordingly, there exists a need for new and improved systems and methods for contract, RFP, and/or RFQ prioritization and/or drafting.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a high-level embodiment of an example system that applies a first machine learning model, a first large language model (LLM), and a second LLM for contract prioritization and proposal drafting.

FIG. 2 illustrates a detailed embodiment of the example system for performing the methods described herein.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

As used herein, “contract,” RFP,” and “RFQ” may be used interchangeably.

In some embodiments, the methods and systems described herein may be used for government contracting. In some embodiments, the methods and systems described herein may be used for helping veterans apply for medical and/or disability benefits. In some embodiments, the methods and systems described herein may be used to help a person apply to one or more government jobs (e.g., determine qualifications, write government resumes, etc.). In some embodiments, the methods and systems described herein may be used to help disabled and/or elderly people apply for social security benefits.

Conventional government contracting processes include contract selection (i.e., a large number of contracts exist at any given time; and employees of a company can select which contracts to pursue). Employees review the contract for proposal requirements and summarize contract requirements. Employees draft a proposal and other employees review the proposal, which is iteratively performed until a satisfactory proposal is finalized. The company submits the proposal with an unknown likelihood of success. The company receives the decision and may repeat the process.

To improve the above process, one or more Al models such as large language models (LLMs) may be trained and applied to enable contract, RFP, and/or RFQ prioritization (e.g., ranking) and/or proposal drafting. The contents of the drafts generated by the systems and methods described herein can include, but is not limited to, Statement of Work (SOW), project details, performance expectations, deliverables, administrative and contractual requirements, proposal preparation instructions, proposal creation, evaluation criteria, resource requirements, and the like.

In some embodiments, the systems and methods described herein may use LLMs to identify opportunities in which to submit a contract, RFP, RFQ, and/or proposal. Such opportunities may be identified by using one or more LLMs to parse contract opportunities on U.S. government websites such as SAM.gov, for example. Parsing websites to identify relevant contract opportunities using an LLM can include recognizing, translating, comparing, predicting, and/or summarizing opportunities in order to generate parsed data. The parsed data may be used by the LLM to generate text content including, but not limited to, RFPs, RFQs, and/or proposals.

The systems and methods described herein may also use LLMs to interpret requirements for a particular identified contract. Because government RFPs and RFQs are typically detailed and complex, the LLM may interpret and analyze the scope, terms, and conditions for use in generating a bid and/or proposal. Interpreting requirements for an identified contract may include using an LLM to parse the language of the requirements to compare and attempt to match company assets, resources, schedule, and/or requirements to the requirements of the identified contract. In some embodiments, this may include qualifying (e.g., evaluating) the contract with respect to the capabilities, resources, and strategic goals of the company.

The systems and methods described herein may also use LLMs to develop and/or generate a competitive proposal based on the identified contract, prior company contracts, and/or other third party contracts. For example, the LLM may draft textual and/or graphical content for a proposal to ensure that the proposal meets (or exceeds) all the requirements of the identified contract. In some embodiments, the LLM may obtain and use prior technical approaches performed by the company and/or prior performance of the company in other related contracts. In some embodiments, the LLM may highlight particular team qualifications based on the prior technical approaches and/or prior performance of the company or the team member. In some embodiments, the LLM may generate multiple bids for inclusion in a contract based on analysis of prior company-based contracts and/or contracts/proposals belonging to other third parties that may be unrelated to the company. For example, the LLM may learn an effectivity rate for past contracts and/or for other third party contracts and use such learning as a basis for generating new competitive proposals.

The systems and methods described herein may also use LLMs to read and interpret proposals and/or contracts drafted by the LLM. The systems and methods described herein may also use LLMs to read and interpret proposals and/or contracts drafted by other users as a basis for generating new RFQs, RFPs, and/or proposals.

The systems and methods described herein may also use LLMs to assess an ability of the company to deliver proper (and predefined) compliance with aspects of a particular identified contract. This may include ensuring that any generated proposals, for example, by the LLM account for and meet expectations for compliance to laws, regulations, and contract requirements.

The systems and methods described herein may also use LLMs to assess resource constraints. For example, an LLM can review prior proposals generated by the company (and/or other proposals generated by third parties) to find, qualify, quantify, and/or bid on particular contracts without having to outlay human resources to do so. This can alleviate the need for hiring and managing a conventional multidisciplinary team that would be utilized to generate proposals, RFPs, RFQs, etc. When the LLM is trained and programmed to assess, learn, predict data in order to generate proposals, RFPs, RFQs, etc., a multidisciplinary team may not be utilized because the assessments and proposal generation may instead be generated by the LLM using trained data, past data, and/or user input.

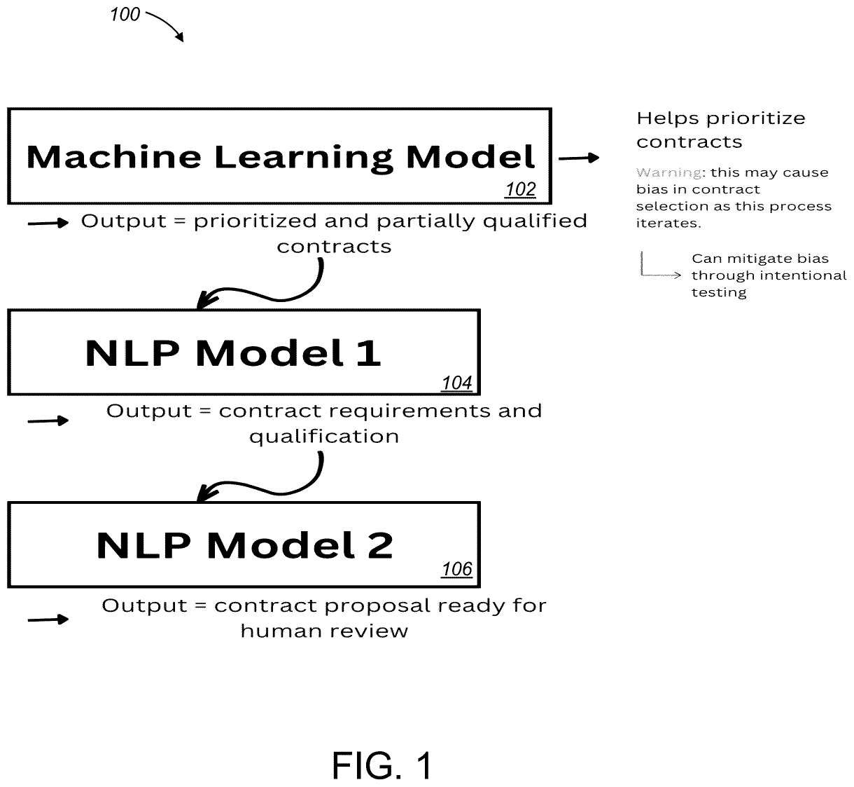

As shown in FIG. 1, an improved process 100 may include: training a machine learning model 102 with data related to the contracts, companies, requirements, and/or historical proposals. The data may be enriched using feature engineering to generate and utilize any number of variables. The process 100 may further include predicting the probability of winning a contract using the trained machine learning algorithm; and/or prioritizing a list of contracts based on the probability of winning the contract. The process 100 may utilize the trained machine learning model 102. The process 100 may optionally further include: receiving a selection of a contract to bid on. The selection may be based on the probability, such that a higher probability indicates a higher likelihood of successfully winning the bid for the contract. In some embodiments, receiving a selection may further include receiving an input including a managerial decision regarding a contract to bid on. In some embodiments, the process includes optimizing an expected return-on-investment (ROI) for one or more selected contracts. In some embodiments, the process 100 further includes receiving one or more decision inputs into the model as a feedback into the model to improve model training, for example.

In some embodiments, one large language model (LLM) may be trained and/or applied to perform contract prioritization and/or proposal drafting. In some embodiments, one or more LLMs may be trained and/or applied to perform contract prioritization and/or proposal drafting. In some embodiments, two or more LLMs may be trained and/or applied to perform contract prioritization and/or proposal drafting.

For example, as shown in FIG. 1 (with additional, a computer-implemented process 100 of generating contract proposal documents may include: training a first LLM 104 (e.g., that uses natural language processing (NLP)) and uses existing contracts associated with a single or multiple companies. The process 100 may further include applying unsupervised learning to orient a first LLM 104 toward the specific domain of government contracts. The process 100 may further include using supervised learning from the previous contracts to fine-tune the first LLM 104 to increase predictive potential of the first LLM 104. The process 100 may further include tuning the first LLM to read and interpret government contracts. The process 100 may further include adjusting one or more settings or parameters of the first LLM 104 to increase a predictive capability of the first LLM 104. In some embodiments, the process 100 may optionally include using reinforcement learning on the first LLM 104 to cause the first LLM 104 to output specific answers that mimic an expert proposal writer. In some embodiments, the first LLM 104 may be created or selected based on accuracy and/or legal ability to utilize the model. In some embodiments, a coding language, model type, one or more model parameters, one or more model features, etc. may be varied.

Further for example, as shown in FIG. 1, the process 100 may further include generating a proposal contract (document). For example, the process 100 may include: training a second LLM 106 (e.g., that uses natural language processing (NLP)) and existing contracts and/or proposals associated with a single or multiple companies. The process 100 may further include using unsupervised learning to orient the second LLM 106 toward the specific domain of government contracts and/or proposals. The process 100 may further include using supervised learning from the previous contracts and/or proposals to fine-tune the second LLM 106 to increase a predictive potential of the second LLM 106. The process 100 may further include tuning the second LLM 106 to read and interpret one or more contracts and/or proposals and adjusting one or more settings or parameters of the second LLM 106 to increase a predictive capability of the second LLM 106. In some embodiments, the process 100 may optionally include using reinforcement learning on the second LLM 106 to increase a specific tone and/or answers that mimic an expert proposal writer or that mimic another selectable user type. This process may be iterated on to continually add data for further optimization.

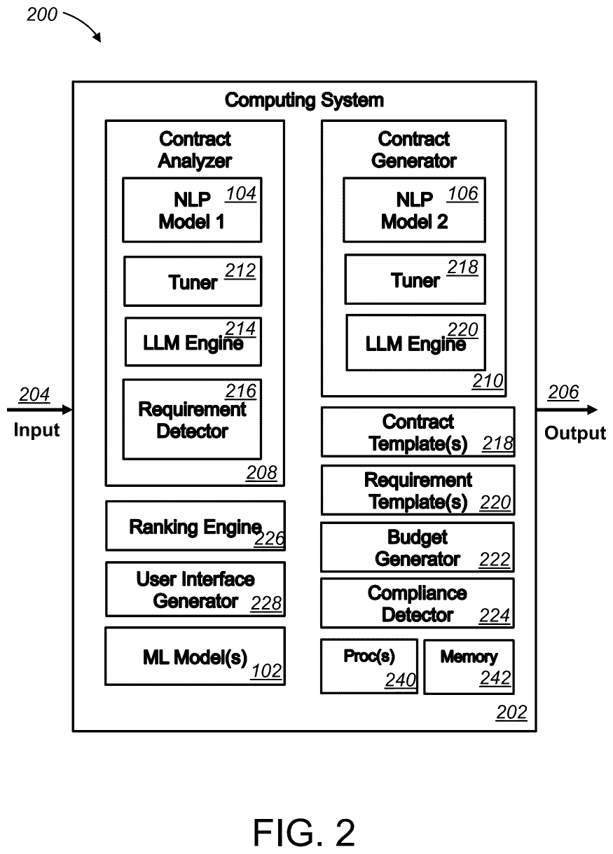

FIG. 2 illustrates a detailed embodiment of the example system 200 for performing the methods described herein. The system 200 includes at least one computing device 202. The computing device 202 may receive one or more inputs 204 to generate output 206, such as contract proposal documents, bids, likelihoods of winning particular contract work, etc.

The computing system 202 includes a contract analyzer 208 and a contract generator 210. The contract analyzer 208 may function to analyze information such as historical contract proposals, contract requirements, and/or other contract or bid related data for purposes of learning how such information can be used to generate new contract proposal (documents) and/or update other contract proposal (documents).

In some embodiments, one or more LLMs may be executed locally on a computing system (e.g., computing system 202), for example for confidential contracts and/or contracts that include security clearance specifications. The local computing system may, for example, be disconnected from the Internet. In some embodiments, one or more LLMs may be executed on a distributed network of computing systems. In some embodiments, one or more LLMs may be executed on a cloud computing system. In some embodiments, one or more LLMs may be executed through third-party software (generally accessed through, but not limited to, APIs). The contract analyzer includes a first NLP model 104, a tuner 212, and a first LLM engine 214, and a requirement detector 216.

In some embodiments, the contract analyzer 208 may also determine a likelihood of a particular company winning a contract bid.

In some embodiments, the first LLM 104 may be used to read and interpret a plurality of contracts as input 204. In some embodiments, the first LLM 104 may be used to obtain contracts through a web search. In some embodiments, the first LLM 104 may be used to obtain contracts programmatically through automation (e.g., API, web scraping, etc.). In some embodiments, the first LLM 104 may be used to determine: which one or more contracts from the plurality of contracts the company qualifies for; and/or one or more requirements for developing a proposal.

The contract generator 210 may function to obtain contract text from the contract analyzer 208 and generate contract proposal documents using the contract text.

The contract generator 210 includes the second NLP model 106, a tuner 218, and a second LLM engine 220.

In some embodiments, using one or more contract requirements output 206 from the first LLM may be received as an input into the second LLM. In some embodiments, the second LLM may be used to generate a proposal. In some embodiments, a decision outcome may be input back into the first and/or the second LLM for additional model training.

The computing system 202 also includes one or more processors 240 and memory 242. The one or more processors 240 may include one or more devices capable of executing instructions, such as instructions stored by the memory 242, to perform various tasks associated with operating the system 200. The memory 242 can include one or more non-transitory computer-readable storage media. The memory 242 may store instructions and data that are usable in combination with processors 240 to execute the processes/algorithms described herein, the machine learning models (e.g., model 104, model 106, LLM engines 214, 220, ML model 102, or the like). The memory 242 may also function to store or have access to the data associated with the contract analyzer 208, the contract generator 210, contract templates, 218, requirement templates 220, budget generator 222, compliance detector 224, ranking engine 226, and/or user interface generator 228. Additional computing components may be included, but are not shown for brevity, including, but not limited to a power supply, a communication module, a display, additional processors, and memory, etc.

In some embodiments, any of the models described herein may use natural language processing. Natural language processing (NLP) is a subfield of artificial intelligence and computer science that focuses on the tokenization of data—the parsing of human language into its elemental pieces. By combining computational linguistics with statistical machine learning techniques and deep learning models, NLP enables computers to process human language in the form of text or voice data. Lemmatization and part of speech tagging enable a deep understanding of language, including context, the intent, and/or sentiment of a speaker or writer. Statistical NLP combines computer algorithms with machine learning and deep learning models to automatically extract, classify, and label elements of text and voice data and then assign a statistical likelihood to each possible meaning of those elements. Deep learning models and learning techniques based on convolutional neural networks (CNNs) and recurrent neural networks (RNNs) enable NLP systems that ‘learn’ as they work and extract ever more accurate meaning from huge volumes of raw, unstructured, and unlabeled text and voice data sets.

As used herein, “unsupervised learning” may include a first step in training a language model. The model is fed a large amount of text data and asked to predict the next word in a sentence, given all the previous words. The model isn't given any explicit labels or targets apart from the text itself. An example of this would be training the GPT-3 model on a large corpus of internet text. The model learns to generate text by predicting the next word in a sentence, learning grammar, facts about the world, and even some reasoning abilities in the process, all without any explicit supervision.

As used herein, “supervised learning” may include fine-tuning a model on a specific task using supervised learning. For example, a dataset of movie reviews may include labeled reviews as “positive” or “negative”. The model can be trained to predict these labels given the review text. This is a form of supervised learning because you're providing the model with explicit labels (the positive/negative rating) for each piece of input data (the review text).

As used herein, “reinforcement learning” includes training a model to make a series of decisions that lead to an end goal, with the model receiving feedback in the form of rewards or punishments. For LLMs, an example could be the task of dialogue generation, where the model is rewarded based on the quality of the conversation. For example, initial versions of well-known chatbots were trained using a form of reinforcement learning from human feedback. In some embodiments of such chatbots, human Al trainers provided conversations, playing both the user and an Al assistant. The trainers also had access to model-written suggestions to help compose responses. The model was fine-tuned to predict the trainer's actions, creating a reward model that was used to optimize the model's responses.

Each of these methods has its strengths and is suited to different tasks. Unsupervised learning can leverage large amounts of unlabeled data, supervised learning can fine-tune the model for specific tasks with high precision, and reinforcement learning can optimize for complex, multi-step tasks where the best action depends on the context.

In some embodiments, tuning a machine learning model, also known as hyperparameter optimization or hyperparameter tuning, is the process of adjusting the settings of a machine learning model to improve its performance. This involves changing the values of the model's hyperparameters, which are parameters that aren't learned from the data during training but are set before the training process begins.

Hyperparameters can include (but are not limited to) factors like:

Learning Rate: It determines the step size that is taken to reach the minimum of the loss function during training. If the learning rate is too high, the model may overshoot the minimum, and if it's too low, the model may take too long to converge or may get stuck in a local minimum.

Batch Size: This is the number of training examples used in one iteration. Larger batch sizes can lead to faster training, but they also require more memory and may lead to less accurate models.

Number of Epochs: This is the number of times the learning algorithm will work through the entire training dataset. More epochs can lead to a more accurate model, but also can lead to overfitting if the number is too high.

Regularization Parameters: Regularization is a technique used to prevent overfitting by adding a penalty term to the loss function. The strength of the penalty is controlled by a hyperparameter.

When tuning Large Language Models like GPT-3 or Falcon, examples could include: Decoding strategies: Parameters like temperature (which controls the randomness of the model's output) and top-k or top-p sampling (which limit the model's choices to a subset of the most likely next tokens) can be tuned to balance diversity and coherence in the model's responses.

Model architecture parameters: Parameters like the number of attention heads, the dimensionality of the embeddings, and the number of transformer blocks can also be tuned. However, in practice, these are often left at their default values as defined by the pretrained model, as changing them would require retraining the model from scratch.

Fine-tuning parameters: When fine-tuning a large language model on a specific task, the learning rate, batch size, and number of training steps can all be tuned to get the best performance on that task.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of one or more processors on a quantum computer, computing system, and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “large language model” may include, and is contemplated to include, a plurality of large language models. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### Examples

Example 1. A computer-implemented method to train or guide a machine learning model to generate a contract proposal document, the method comprising: receiving a request to generate a contract proposal, the request including a plurality of requirements and at least one of: an industry indication and a service indication; identifying, based on a first natural language model, a plurality of contract documents that satisfy at least one of the plurality of requirements; training, based on the first natural language model, the machine learning model to parse textual data in the identified plurality of contract documents; training, based on a second natural language model, the machine learning model to use the parsed textual data to generate input for the contract proposal document, wherein the generated input includes text that mimics semantics of the textual data to adhere to the plurality of requirements; and generating the contract proposal document using the generated input according to the training based on the first natural language model and the training based on the second natural learning model.

Example 2. The computer-implemented method of any one of the preceding examples, but particularly Example 1, wherein: the first natural language model is a first large language model; and the second natural language model is a second large language model.

Example 3. The computer-implemented method of any one of the preceding examples, but particularly Example 1, wherein mimicking the semantics of the textual data comprises: determining semantics and tone associated with work product generated by a selected user type; and generating the text for insertion into the contract proposal document according to the semantics and tone associated with the work product.

Example 4. The computer-implemented method of any one of the preceding examples, but particularly Example 3, wherein the selected user type comprises an export proposal writer, a novice proposal writer, or an engineer.

Example 5. The computer-implemented method of any one of the preceding examples, but particularly Example 1, wherein, in response to determining that one or more of the plurality of requirements is unsatisfied, updating the generated contract proposal document to include additional input to satisfy each unsatisfied requirement in the plurality of requirements.

Example 6. The computer-implemented method of any one of the preceding examples, but particularly Example 1, wherein the training based on the first natural language model comprises: performing unsupervised learning to select at least one contract document from the identified plurality of contract documents by comparing at least one field of the identified plurality of contract documents to match the industry indication or the service indication associated with the request; and performing supervised learning to parse the plurality of contract documents that meet at least one of the plurality of requirements and modify at least one model parameter to achieve a predefined predictive capability; and iterating the training based on the first natural language model upon determining that additional contract documents are available to parse.

Example 7. The computer-implemented method of any one of the preceding examples, but particularly Example 1, wherein the training based on the second natural language model comprises: performing unsupervised learning to select at least one contract document from the identified plurality of contract documents by comparing at least one field of the identified plurality of contract documents to match the industry indication or the service indication associated with the request; performing supervised learning to parse the plurality of contract documents that meet at least one of the plurality of requirements and modify at least one model parameter to achieve a predefined predictive capability; and performing reinforcement learning to generate additional textual content to be included in the contract proposal document.

Example 8. A computer-implemented method for predicting a probability of winning contract work, the method comprising: obtaining information comprising a plurality of identifiers, a plurality of contract documents, a plurality of available contract work, and historical data about awarded contracts; determining a likelihood, based on the obtained information and for each of the plurality of identifiers, of winning the respective contract work according to the plurality of contract documents and the historical data about awarded contracts, the determining comprising; ranking the determined likelihoods of winning the respective contract work; generating, based on the ranking, at least one bid and a contract proposal document for contract work having a ranking above a predefined level.

Example 9. A computer-implemented method of prioritizing contracts, the method comprising: training a first LLM model using existing contracts associated with a single or multiple companies; applying unsupervised learning to orient the first LLM toward government contracts; applying supervised learning from the previous contracts to tune the first LLM to increase predictive potential of the first LLM; tuning the first LLM to read and interpret government based contracts; adjusting one or more settings or parameters of the first LLM to increase a predictive capability of the first LLM; training a second LLM using available contracts associated with the single or multiple companies; applying unsupervised learning to orient the second LLM toward the government based contracts; applying supervised learning from the previous contracts to tune the second LLM to increase a predictive potential of the second LLM; tuning the second LLM to read and interpret the available contracts; adjusting one or more settings or parameters of the second LLM to increase a predictive capability of the second LLM; and applying reinforcement learning on the first LLM to cause the first LLM to output specific answers that mimic an expert proposal writer; and generating a new contract proposal document and inserting the specific answers into the contract proposal document.

Example 10. The computer-implemented method of any one of the preceding examples, but particularly Example 9, further comprising: applying reinforcement learning on the second LLM to increase a tone that mimic an expert proposal writer or that mimic another selectable user type.

What is claimed is:

1. A computer-implemented method to train or guide a machine learning model to generate a contract proposal document, the method comprising:
receiving a request to generate a contract proposal, the request including a plurality of requirements and at least one of: an industry indication and a service indication;
identifying, based on a first natural language model, a plurality of contract documents that satisfy at least one of the plurality of requirements;
training, based on the first natural language model, the machine learning model to parse textual data in the identified plurality of contract documents;
training, based on a second natural language model, the machine learning model to use the parsed textual data to generate input for the contract proposal document, wherein the generated input includes text that mimics semantics of the textual data to adhere to the plurality of requirements; and
generating the contract proposal document using the generated input according to the training based on the first natural language model and the training based on the second natural learning model.

2. The computer-implemented method of claim 1, wherein:
the first natural language model is a first large language model; and
the second natural language model is a second large language model.

3. The computer-implemented method of claim 1, wherein mimicking the semantics of the textual data comprises:
determining semantics and tone associated with work product generated by a selected user type; and
generating the text for insertion into the contract proposal document according to the semantics and tone associated with the work product.

4. The computer-implemented method of claim 3, wherein the selected user type comprises an export proposal writer, a novice proposal writer, or an engineer.

5. The computer-implemented method of claim 1, wherein, in response to determining that one or more of the plurality of requirements is unsatisfied, updating the generated contract proposal document to include additional input to satisfy each unsatisfied requirement in the plurality of requirements.

6. The computer-implemented method of claim 1, wherein the training based on the first natural language model comprises:
performing unsupervised learning to select at least one contract document from the identified plurality of contract documents by comparing at least one field of the identified plurality of contract documents to match the industry indication or the service indication associated with the request; and
performing supervised learning to parse the plurality of contract documents that meet at least one of the plurality of requirements and modify at least one model parameter to achieve a predefined predictive capability; and
iterating the training based on the first natural language model upon determining that additional contract documents are available to parse.

7. The computer-implemented method of claim 1, wherein the training based on the second natural language model comprises:
performing unsupervised learning to select at least one contract document from the identified plurality of contract documents by comparing at least one field of the identified plurality of contract documents to match the industry indication or the service indication associated with the request;
performing supervised learning to parse the plurality of contract documents that meet at least one of the plurality of requirements and modify at least one model parameter to achieve a predefined predictive capability; and
performing reinforcement learning to generate additional textual content to be included in the contract proposal document.

8. A computer-implemented method for predicting a probability of winning contract work, the method comprising:
obtaining information comprising a plurality of identifiers, a plurality of contract documents, a plurality of available contract work, and historical data about awarded contracts;
determining a likelihood, based on the obtained information and for each of the plurality of identifiers, of winning the respective contract work according to the plurality of contract documents and the historical data about awarded contracts, the determining comprising;
ranking the determined likelihoods of winning the respective contract work;
generating, based on the ranking, at least one bid and a contract proposal document for contract work having a ranking above a predefined level.

9. A computer-implemented method of prioritizing contracts, the method comprising:
training a first LLM model using existing contracts associated with a single or multiple companies;
applying unsupervised learning to orient the first LLM toward government contracts;
applying supervised learning from the previous contracts to tune the first LLM to increase predictive potential of the first LLM;
tuning the first LLM to read and interpret government based contracts;
adjusting one or more settings or parameters of the first LLM to increase a predictive capability of the first LLM;
training a second LLM using available contracts associated with the single or multiple companies;
applying unsupervised learning to orient the second LLM toward the government based contracts;
applying supervised learning from the previous contracts to tune the second LLM to increase a predictive potential of the second LLM;
tuning the second LLM to read and interpret the available contracts;
adjusting one or more settings or parameters of the second LLM to increase a predictive capability of the second LLM; and
applying reinforcement learning on the first LLM to cause the first LLM to output specific answers that mimic an expert proposal writer; and
generating a new contract proposal document and inserting the specific answers into the contract proposal document.

10. The computer implemented method of claim 9, further comprising:
applying reinforcement learning on the second LLM to increase a tone that mimic an expert proposal writer or that mimic another selectable user type.
